(19) United States
(12) Patent Application Publication
(10) Pub. No.: US 2012/0320396 A1
(43) Pub. Date: Dec. 20, 2012

(54) IMAGE FORMING APPARATUS

(75) Inventors: Hideyuki KURAHASHI, Toyokawa-shi (JP); Osamu OKADA, Toyokawa-shi (JP); Teruo NAGASHIMA, Toyohashi-shi (JP); Kenji TSURU, Hachioji-shi (JP)

(73) Assignee: Konica Minolta Business Technologies, Inc., Chiyoda-ku (JP)

(21) Appl. No.: 13/492,952

(22) Filed: Jun. 11, 2012

(30) Foreign Application Priority Data
Jun. 16, 2011 (JP) 2011-134531

(51) Int. Cl. G06K 15/02

(52) U.S. Cl. 358/1.13

(57) ABSTRACT

An image forming unit is accommodated in a space defined by a frame body. An image reader is disposed above the image forming unit. A first supporting member is secured between an upper portion of the frame body and a bottom portion of the image reader and configured to support the image reader to the frame body in a cantilever manner. A second supporting member is secured on an upper portion of the frame body and configured to receive a bottom portion of the image reader supported by the first supporting member in a cantilever manner.

### CROSS-REFERENCE TO RELATED APPLICATIONS

The present application claims priority under 35 U.S.C. §119 to Japanese Patent Application No. 2011-134531, filed Jun. 16, 2011. The contents of this application are incorporated herein by reference in their entirety.

### BACKGROUND OF THE INVENTION

1. Field of the Invention

The present invention relates to an image forming apparatus.

2. Discussion of the Background

Japanese Unexamined Patent Application Publication No. 2003-084517 discloses a technique of supporting a lower portion of an image reader disposed above an image forming unit in an image forming apparatus by a plurality of pillars.

Japanese Unexamined Patent Application Publication No. 2008-070606 discloses a technique of supporting an image forming unit and an image reader with different members to prevent vibration from being transmitted to one another.

When an image forming unit performs a printing operation and/or when an image reader performs a reading operation, vibration caused by a drive means such as a motor is generated. In this case, with the technique described in Japanese Unexamined Patent Application Publication No. 2003-084517, the generated vibration is transmitted from one of the image forming unit and the image recorder to the other. As a result, there arises a problem of deterioration in the printing performance and the reading performance.

On the other hand, the problem of vibration transmission between the image forming unit and the image recorder can be overcome with the technique described in Japanese Unexamined Patent Application Publication No. 2008-070606. However, here arises a new problem of increasing the weight, the size and the manufacturing cost of the image forming apparatus.

### SUMMARY OF THE INVENTION

Therefore, it is an object of the present invention to provide an image forming apparatus which can successfully perform an image formation and an image reading.

According to an aspect of the present invention, an image forming apparatus includes a frame body, an image forming unit, an image reader, a first supporting member, and a second supporting member. The image forming unit is accommodated in a space defined by the frame body. The image reader is disposed above the image forming unit. The first supporting member is secured between an upper portion of the frame body and a bottom portion of the image reader and configured to support the image reader to the frame body in a cantilever manner. The second supporting member is secured on an upper portion of the frame body and configured to receive a bottom portion of the image reader supported by the first supporting member in a cantilever manner.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of an MFP;

FIG. 2 is a cross-sectional front view of an inner structure of the MFP;

FIG. 3 is a plan diagram illustrating of a structure of a scanner;

FIG. 4 is a perspective diagram illustrating a structure around a frame body;

FIG. 5 is a perspective diagram illustrating the structure around the frame body;

FIG. 6 is a diagram describing jitter in a printed image;

FIG. 7 is a diagram describing jitter in a printed image;

FIG. 7 is a diagram describing jitter in a printed image;

FIG. 8 is a graph illustrating a relationship between a visual acceptability index and a spatial frequency of jitter; and

FIG. 9 is a graph illustrating a relationship between a transmission rate of vibration and a frequency of vibration.

### DESCRIPTION OF THE PREFERRED EMBODIMENTS

The embodiments will now be described with reference to the accompanying drawings, wherein like reference numerals designate corresponding or identical elements throughout the various drawings.

### 1. Overview of MFP

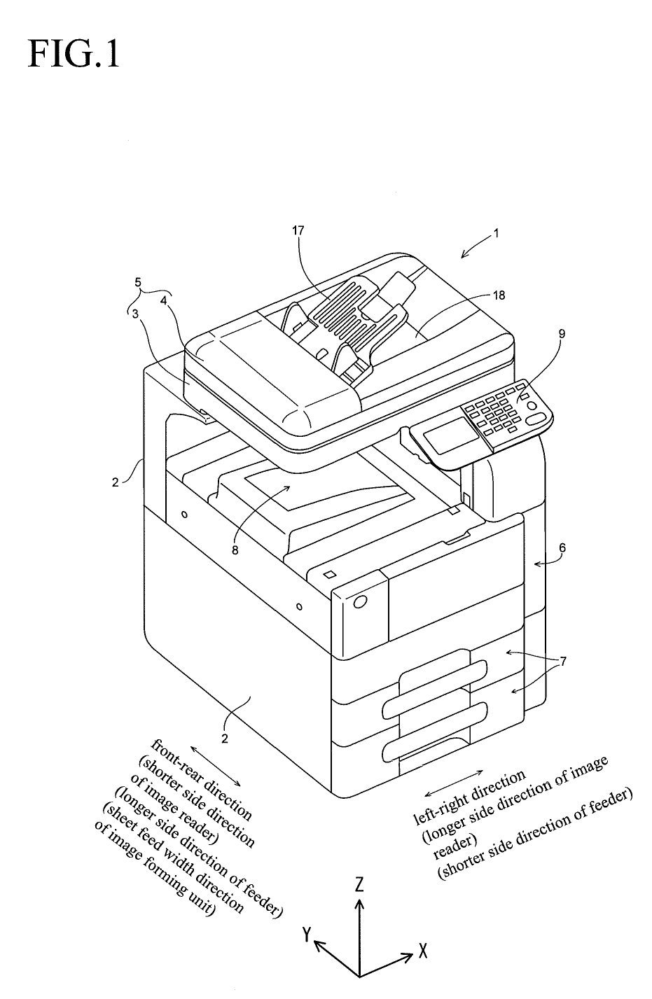

FIG. 1 is a perspective view of a multi-functional printer 1 (hereinafter, referred to as an MFP) as an example of an image forming apparatus. The MFP 1 has multiple functions including a copying function, a scanning function, a printing function, and a facsimile function, and is capable of data communications through networks (communication networks) such as a LAN and a phone line.

Specifically, the MFP 1 is capable of outputting digital image data read from a document and subjected to digital conversion to another computer through a network, or inputting digital image data from another computer through a network and printing the digital image data, or transmitting and receiving FAX data.

As shown in FIG. 1, the MFP 1 mainly includes an image reader 5, an image forming unit 6, a feeder 7, a discharged sheet reservoir 8, and an operation panel 9.

To clarify the directional relationship, FIG. 1 and some subsequent figures are provided with an XYZ orthogonal coordinate system, where the Z axis direction is a vertical direction and XY plane is a horizontal plane.

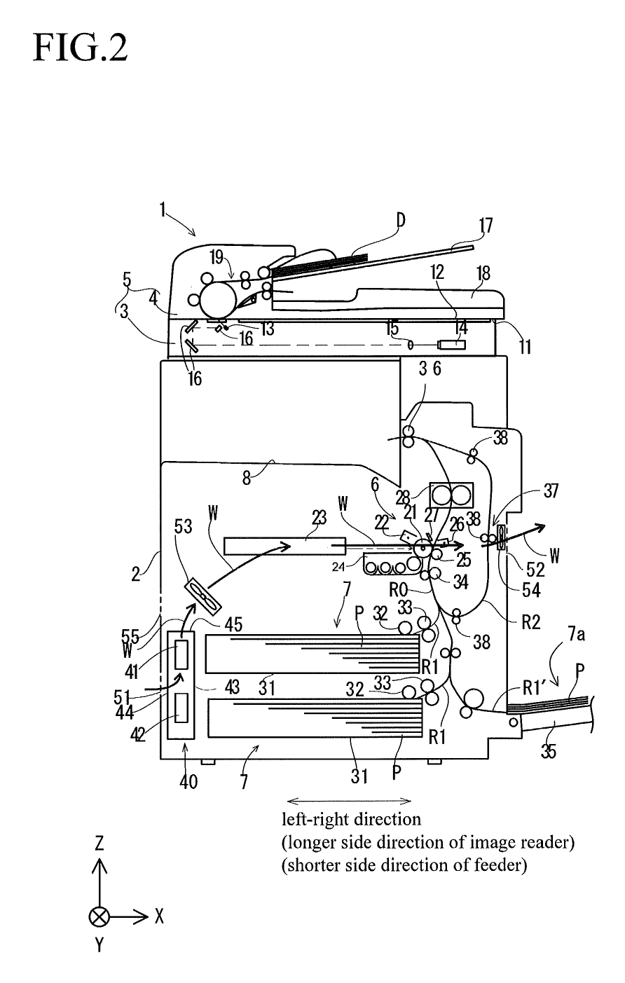

In the following description, terms (for example, “left and right” and “upper and lower”) indicating specific directions and positions are used where necessary. In this respect, the direction perpendicular to the paper plane of FIG. 2 (namely, the Y axis direction) is defined as a front view and a basis. The terms are used for the sake of description and will not limit the technical scope of the present invention.

The image reader 5 is disposed in an upper portion of a main body 2 of the MFP 1, and includes a scanner 3 and an automatic document feeder 4 (hereinafter referred to as an ADF). The image reader 5 synchronizes the scanner 3 with the ADF 4 so as to optically read an image on each document in the ADF 4, thus acquiring digital image data. Specifically, the ADF 4 conveys documents to the scanner 3 one at a time, and the scanner 3 reads the image on each document when each document passes through a predetermined reading position, thus acquiring digital image data.

The feeder 7 that accommodates recording media P is disposed in a lower portion of the main body 2. The image forming unit 6 is disposed between the image reader 5 and the feeder 7 in the main body 2, and prints a toner image corresponding to digital image data onto the recording media P by known electrophotography. Thus, the image reader 5 is disposed above the image forming unit 6 that is disposed above the feeder 7. The feeder 7 supplies the recording media P to the image forming unit 6 one at a time. The image forming unit 6 prints a toner image onto the recording medium P based on digital image data acquired by the image reader 5 or through a network. In the main body 2, a recessed space between the image reader 5 and the image forming unit 6 serves as the discharged sheet reservoir 8 constituting a discharged sheet space. The discharged sheet reservoir 8 is where the recording medium P having a toner image printed through the image processor 6 is discharged.

The operation panel 9 is an operational unit that receives an input from a user of the MFP 1 (hereinafter, also simply referred to as “user”). As shown in FIG. 1, the operation panel 9 includes a plurality of keys (buttons) on a front side (forward side: closer side as viewed from the user) of the main body 2.

A user operates the keys by referring to a display screen and the like on the operation panel 9 when the user executes various kinds of setting of a function selected from the various functions of the MFP 1 and instructs the MFP 1 to execute operations.

The MFP 1 is a so-called A4 compatible printer, and can store, in the feeder 7, the recording medium P of A4 size as the maximum size in a lateral feed position to enter the image forming unit 6 with a longer side first. As shown in FIG. 2, the feeder 7 includes removable sheet feed cassettes 31. The sheet feed cassettes 31 each accommodate the recording media P. The length of the sheet feed cassettes 31 in the conveyance direction of the recording medium P is smaller than the length of the sheet feed cassettes 31 in a direction orthogonal to the conveyance direction of the recording medium P. Here, the recording medium P of A4 in landscape has a longer side length L (width) of 297 mm and a shorter side length N (conveyance direction length) of 210 mm.

### 2. Inner Structure of MFP

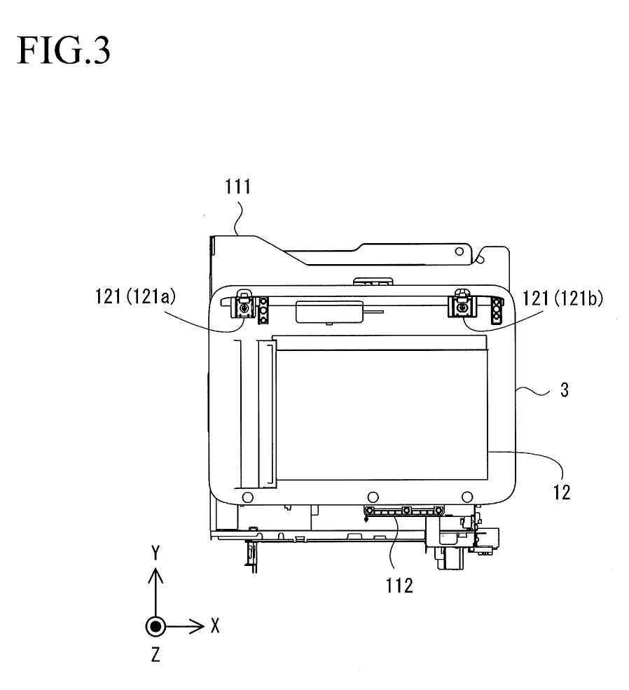

FIG. 2 is a cross-sectional front view of an inner structure of the MFP 1, and FIG. 3 is a plan diagram illustrating of a structure of the scanner 3. The inner structure of the MFP 1 will be described with reference to FIG. 2 and FIG. 3.

The scanner 3 of the image reader 5 in the upper portion of the main body 2 includes a platen 11, a light source device 13, an image sensor 14, an imaging lens 15, and a mirror group 16. The platen 11 includes a platen glass 12 on an upper surface side. The light source device 13 irradiates a document D with light. The image sensor 14 photoelectrically converts reflected light from the document D into an image signal. The imaging lens 15 forms an image on the image sensor 14 from the reflected light. The mirror group 16 sequentially reflects the reflected light from the document D to be incident on the imaging lens 15. The platen 11 incorporates the light source device 13, the image sensor 14, the imaging lens 15, and the mirror group 16.

To read the document D on the platen glass 12, the document D is irradiated with light from the light source device 13 moving in the longer side direction (left-right direction of the main body 2) of the image reader 5 together with the mirror group 16. The reflected light from the document D is sequentially reflected by the mirror group 16 to be incident on the imaging lens 15 that in turn forms an image on the image sensor 14 from the reflected light. As described above, the mirror group 16 is movable in a longer side direction of the image reader 5, and moves on a lower portion of the platen glass 12 to guide the reflected light from the document D on the platen glass 12 to the image sensor 14. The image sensor 14 performs photoelectric conversion for each pixel in accordance with the intensity of the incident light to produce an image signal (RGB signal) corresponding to the image on the document D. The image signal (RGB signal) is output to a control board 42 described later.

As shown in FIG. 3, a plurality of (two in this embodiment) hinges 121 (121a and 121b) are disposed on an upper surface side of the platen 11. The hinges 121 (121a and 121b) allow the ADF 4 to be opened and closed with respect to the platen 11 of the scanner 3.

The ADF 4 also has a function of putting the document D in close contact with the platen glass 12 by being laid on the document D on the platen glass 12. The ADF 4 includes a document placement tray 17 and a document discharged tray 18. To read the document D placed on the document placement tray 17, the document D is conveyed to a reading position by a document conveyance mechanism 19 including a plurality of rollers. During the conveyance, a portion of the document D at the reading position is irradiated with light from the light source device 13. The image is formed on the image sensor 14 from the reflected light through the mirror group 16 and the imaging lens 15. Then, the image sensor 14 converts the reflected light into the image signal (RGB signal) corresponding to the image on the document D, and outputs the image signal to the control board 42. Then, the document D is discharged onto the document discharged tray 18.

To read the document D of A4 size, which is the maximum size, with the image reader 5, the document D is set to have the longer side aligned with the left-right direction of the main body 2 as viewed from the front. In other words, the document D is set to have the longer side orthogonal to the sheet feed width direction of the image forming unit 6 (front-rear direction of the main body 2). The document D on the document placement tray 17 in the ADF 4 is longitudinally fed in the left-right direction of the main body 2 with the shorter side first. Thus, the longer and shorter sides of the image reader 5 are respectively aligned with the left-right and front-rear directions of the main body 2.

As shown in FIG. 2, the image forming unit 6 transfers a toner image formed on a photoreceptor drum 21 as an image carrier onto a recording medium P through a known electrophotography, and conveys the recording medium P after the transfer to a fixing unit 28 to be heated and pressed so that the toner image is fixed onto the recording medium P. Around the photoreceptor drum 21, a charger 22, an exposing unit 23, a developer 24, a transfer roller 25, a separator 26, and a cleaner 27 are arranged in this order in the rotational direction of the photoreceptor drum 21 (in the counterclockwise direction of FIG. 2).

The charger 22 uniformly charges a surface of the photoreceptor drum 21. The exposing unit 23 forms an electrostatic latent image on the surface of the photoreceptor drum 21. The developer 24 develops the electrostatic latent image on the photoreceptor drum 21 into a toner image (visible image). The transfer roller 25 transfers the toner image on the photoreceptor drum 21 onto the recording medium P. The photoreceptor drum 21 and the transfer roller 25 define, at the position of their contact, a transfer position. The separator 26 separates the recording medium P from the photoreceptor drum 21. The cleaner 27 removes un-transferred toner remaining on the photoreceptor drum 21. The maximum sheet feed widths (the maximum value of the width direction length orthogonal to the conveyance direction of the recording medium P) of the photoreceptor drum 21, the transfer roller 25, and the like are slightly larger than the longer side length L (=297 mm) of the recording medium P of A4 in landscape. Thus, the toner image can be transferred onto the recording medium P of A4 in landscape.

The fixing unit 28 includes a fixing roller and a pressure roller. The fixing roller incorporates a fixing heater such as a halogen heater. The pressure roller is opposite the fixing roller. The fixing roller and the pressure roller define, at the portion of their contact, a fixing position. The control board 42 controls power to the fixing heater to keep the fixing heater at a temperature necessary for the fixing. The maximum sheet feed width of the fixing unit 28 is also slightly larger than the longer side length L (=297 mm) of the recording medium P of A4 in landscape. Thus, the recording medium P of A4 in landscape can be heated and pressed. The maximum sheet feed widths of the photoreceptor drum 21, the transfer roller 25, and the like, as well as the fixing unit 28 indicate that, in this embodiment, the maximum sheet feed width of the image forming unit 6 is set to allow the recording medium P of A4 in landscape to be printed.

As shown in FIG. 2, the feeder 7 includes the sheet feed cassettes 31, feeding rollers 32, pairs of separating rollers 33, and pairs of registration rollers 34. The sheet feed cassettes 31 are vertically stacked and each accommodate recording media P. The feeding rollers 32 each feed the recording media P in corresponding one of the sheet feed cassettes 31 one at a time from the top. Each pair of separating rollers 33 separates the picked part of recording media P into individual sheets. The pairs of registration rollers 34 determine the timing at which to feed the fed recording media P to the transfer position. The recording media P in each of the sheet feed cassettes 31 are fed to a main conveyance path R0 through a sheet feed path R1 one at a time from the top by the driving rotation of a corresponding set of the feed roller 32 and the pair of separation rollers 33. The main conveyance path R0 serves as a main path through which the recording medium P is subjected to the image forming (printing) steps. The sheet feed path R1 is provided to each of the sheet feed cassettes 31. The sheet feed paths R1 each join the main conveyance path R0 on the upstream side of the pair of registration rollers 34 in the conveyance direction.

The longer side direction of the sheet feed cassette 31 is aligned with the front-rear direction of the main body 2. Thus, the longer side direction of the recording medium P of A4 size accommodated in the sheet feed cassette 31 is aligned with the front-rear direction of the main body 2. Accordingly, the recording medium P of A4 size is laterally fed to the image forming unit 6 with the longer side first.

The longer side direction of the sheet feed cassette 31 is orthogonal to the longer side direction of the image reader 5. This also indicates that in the main body 2, the front-rear length of the upper portion constituting the image reader 5 is shorter than the front-rear length of the lower portion incorporating the sheet feed cassettes 31 and the like. Thus, in the plan view, the lower portion (main body 2) partially overlaps with the upper portion (image reader 5) and sticks out at least from the closer longer side of the upper portion (image reader 5). In this embodiment, due to the appearance of the lower portion (main body 2), open spaces S are respectively formed in front of and behind the upper portion (image reader 5) in the plan view.

The operation panel 9 as an operation unit is disposed in the front open spaces S adjacent to the image reader 5 without sticking out from the outer surface of one shorter side portion of the feeder 7 along the left-right direction of the main body 2 (forward surface portion in this embodiment). The one shorter side portion of the feeder 7 corresponds to the one shorter side of the recording medium P of A4 size. The operation panel 9 has the front end side located more on the inner side than the forward surface of the main body 2 (feeder 7) and thus is entirely embedded in the front open spaces S.

As shown in FIG. 2, a pair of discharging rollers 36 is disposed above the image forming unit 6 that is disposed above the feeder 7. The recording medium P is conveyed vertically upward in the main conveyance path R0. Here, the image forming unit 6 is disposed above the one longer side of the sheet feed cassette 31 in the front-rear direction of the main body 2. The one longer side of the sheet feed cassette 31 corresponds to the one longer side of the recording medium P of A4 size. Thus, the image forming unit 6 of this embodiment is offset to the right side in the main body 2. The main conveyance path R0, the pair of discharging rollers 36, and a circulation conveyance unit 37 are also offset to the right side in the main body 2.

As shown in FIG. 2, the manual feeder 7a used as a sub feeder includes a retractable bypass tray 35. Specifically, the bypass tray 35 through which the recording medium P of a predetermined size can be fed from outside is provided on the one side (right side in the first embodiment) of the main body 2 in the left-right direction. The bypass tray 35 is provided in addition to the regular feeder 7 in the main body 2, and is pivotably mounted to be opened and closed to the one side of the main body 2 in the left-right direction. The recording media P on the bypass tray 35 is fed to the main conveyance path R0 through a manual sheet feed path R1′ one at a time from the top by the driving rotation of a pickup roller and the like.

The maximum sheet feed width of the image forming unit 6 in the MFP 1 corresponds to the longer side length of the recording medium P of A4 in landscape. Thus, the recording medium P of A3 size can be longitudinally fed through the bypass tray 35 to be printed.

The manual feeder 7a with a portion on which the recording medium P is placed defined as “placement portion” is formed to satisfy the following condition. Specifically, the length of the placement portion in the direction orthogonal to the conveyance direction of the recording medium P (i.e., feed direction) is the same as the length of the sheet feed cassette 31 in the direction orthogonal to the conveyance direction of the recording medium P.

The pair of discharging rollers 36 that discharges the printed recording medium P is disposed more on the downstream side than the fixing unit 28 in the main conveyance path R0. The printed recording medium P is discharged onto the discharged sheet reservoir 8 by driving rotation of the pair of discharging rollers 36.

The circulation conveyance unit 37 reversing the recording medium P having the one side printed for duplex printing is disposed in the main body 2 of this embodiment. The circulation conveyance unit 37 includes a pair of reversing rollers that reverses the recording medium P having the one side printed, and pairs of duplex conveyance rollers 38. In the circulation conveyance unit 37, the recording medium P having the one side printed is reversed and is again conveyed to the pair of registration rollers 34 through a circulation conveyance path R2. Here, the pair of discharging rollers 36 is rotatable back and forth, and thus also serves as the pair of reversing rollers. The back and forth rotation of the pair of discharging rollers 36 allows the recording medium P to be discharged from the MFP 1 and to be switched back (backwardly fed) to return into the MFP 1. The upstream side of the circulation conveyance path R2 is branched off from the main conveyance path R0 at a portion between the fixing unit 28 and the pair of discharging rollers 36. The downstream side of the circulation conveyance path R2 joins the main conveyance path R0 at a portion more on the upstream side than the pair of registration rollers 34.

As shown in FIG. 2, in the main body 2, the image forming unit 6 and an electrical component unit 40 are respectively disposed on both sides of the feeder 7 in the shorter side direction. The electrical component unit 40 on the opposite side of the image forming unit 6 across the feeder 7 includes a power source board 41 that controls power to the units (e.g., the image reader 5, the image forming unit 6, and the feeder 7) of the main body 2 and the control board 42 in charge of overall control of operations of the units. The power source board 41 and the control board 42 are surrounded by a shield casing 43 formed by shaping a metal plate into a box. With the shield casing 43 surrounding the boards 41 and 42, noise emitted from the boards 41 and 42 is prevented from spreading, and the grounding of the boards 41 and 42, and the like is improved.

As described above, the image forming unit 6 of this embodiment is above the right longer side of the uppermost sheet feed cassette 31. The electrical component unit 40 is located on the left side of the left longer side portion of the sheet feed cassette 31. Here, the shield casing 43 has a shape of a box that is long in the upper-lower and front-rear directions and short in the left-right direction. The shield casing 43 is vertically installed on the left side of the left longer side of the sheet feed cassette 31. The power source board 41 and the control board 42 are vertically installed in the shield casing 43.

As shown in FIG. 2, a left side plate of the main body 2 includes an intake hole 51 facing the electrical component unit 40, while a right side plate of the main body 2 includes an exhaust hole 52 facing the transfer roller 25 and the duplex conveyance roller 38 at an intermediate portion of the circulation conveyance path R2. A left side plate of the shield casing 43 constituting the electrical component unit 40 includes a casing side intake hole 44 for taking in outer air entered through the intake hole 51, while an upper surface plate of the shield casing 43 includes a casing side exhaust hole 45 for exhausting the air in the shield casing 43. A cooling fan 53 is disposed above the casing side exhaust hole 45 of the shield casing 43. In this embodiment, an exhaust fan 54 is disposed facing the exhaust hole 52 in the main body 2.

Driving rotation of the cooling fan 53 and the exhaust fan 54 makes the air in the shield casing 43 flow upward, and the air in the main body 2 flow from left to right to lower the inner pressure. Thus, the pressure difference is produced between the inside and the outside of the shield casing 43 as well as between the inside and the outside of the main body 2. Accordingly, the outer air is taken in through the intake hole 51. The air that has been taken in through the intake hole 51 and passed through the casing side intake hole 44 flows in the shield casing 43 to take heat from the power source board 41 and the control board 42, and then is guided to the exposing unit 23 through the casing side exhaust hole 45 on the upper surface plate and the cooling fan 53. Then, the air guided to the exposing unit 23 (air warmed while flowing in the shield casing 43) cools part of the image forming unit 6 other than the exposing unit 23 (the photoreceptor drum 21, the developer 24, the transfer roller 25, and the like) and then is exhausted through the exhaust hole 52 (see the direction indicated by an arrow W in FIG. 2).

In other words, as indicated by the arrow W in FIG. 2, the air taken in through the intake hole 51 flows to pass through the electrical component unit 40, the exposing unit 23, and the part of the image forming unit 6 other than the exposing unit 23, and then is exhausted through the exhaust hole 52. Thus, the path extending from the intake hole 51 to the exhaust hole 52 through the electrical component unit 40, the exposing unit 23, and the part of the image forming unit 6 other than the exposing unit 23 is an air flow path W (path of air). Accordingly, the cooling fan 53 is located between the electrical component unit 40 and the image forming unit 6 (specifically, the exposing unit 23) in the air flow path W. The exhaust hole 52 of this embodiment is opened in the right side plate of the main body 2 to be adjacent to a portion between the transfer roller 25 and the fixing unit 28. Thus, the air passing through a portion around the image forming unit 6 also takes heat from a portion around the fixing unit 28 and then is exhausted through the exhaust hole 52 (the air flowing through the air flow path W also takes heat from the portion around the fixing unit 28).

In this embodiment, the left side plate of the main body 2 includes an air intake hole 55 at a portion facing the cooling fan 53 in addition to the intake hole 51. The outer air taken in through the air intake hole 55 is guided to the cooling fan 53 without passing through the electrical component unit 40, and joins the air flow path W after the exposing unit 23. Thus, the air taken in through the air intake hole 55 has a lower temperature than the air that has passed through the electrical component unit 40, thereby exhibiting high cooling effect. A path that reaches the cooling fan 53 from the air intake hole 55 without passing through the electrical component unit 40 is an air introduction path W′ different from the air from path W. The air intake hole 55, the cooling fan 53, the image forming unit 6, the exhaust fan 54, and the exhaust hole 52 are horizontally arranged approximately linearly. Accordingly, the air that does not pass through the electrical component unit 40 and thus has a low temperature flows very smoothly, and thus can exhibit high air cooling effect on the image forming unit 6.

The printing by the MFP 1 will be briefly described. The MFP 1 starts printing upon receiving a start signal, the image signal, and the like. In one-surface printing, the recording medium P fed from the feeder 7 (the sheet feed cassette 31 or the bypass tray 35) is conveyed to the image forming unit 6 through the main conveyance path R0. In the image forming unit 6, the recording medium P is conveyed to the transfer position by the pair of registration rollers 34 at the timing when the forwarding end of the toner image on the photoreceptor drum 21 reaches the transfer position, and the toner image on the photoreceptor drum 21 is transferred onto the recording medium P. After the transfer, the un-transferred toner remaining on the photoreceptor drum 21 is scraped off and removed by the cleaner 27. The recording medium P loaded with an unfixed toner image on one surface is heated and pressed through the fixing position of the fixing unit 28, and thus the unfixed toner image is fixed. The recording medium P after having the toner image fixed (after having the one surface printed) is discharged onto the discharged sheet reservoir 8. In duplex printing, the recording medium P after having the one surface printed is conveyed to the circulation conveyance path R2 for the duplex printing to be reversed and returned to the main conveyance path R0. Thus, a toner image is transferred and fixed onto the other surface of the recording medium P.

### 3. Structure Around Frame Body of Main Body

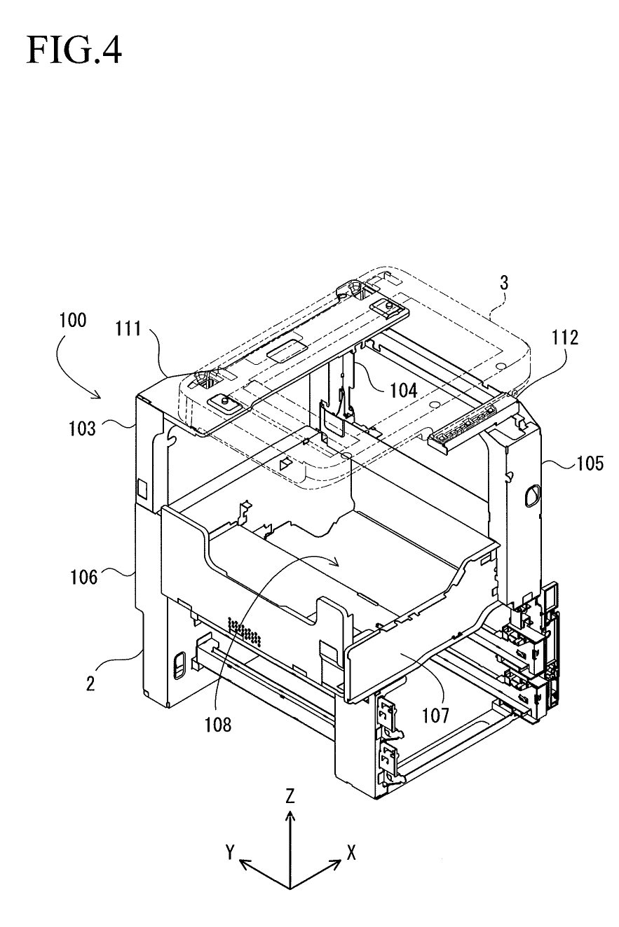

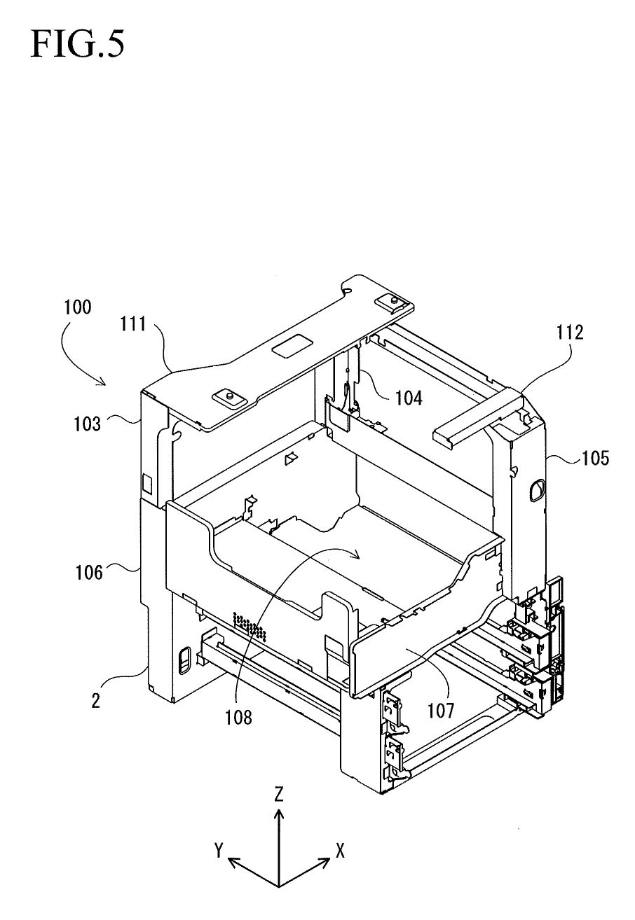

FIG. 4 and FIG. 5 are external perspective diagrams illustrating an example of a structure around a frame body 100. The frame body 100 is a structure forming a framework of the main body 2 and is made of a metal plate for example. As shown in FIG. 4 and FIG. 5, the frame body 100 mainly includes pillars 103, 104, and 105 and frames 106 and 107. Supporting member 111 and 112 are provided at an upper portion of the frame body 100.

The frames 106 and 107 are metallic plates defining a space 108. Thus, the image forming unit 6 is accommodated in the space 108 defined by the frame body 100 (more specifically, the frames 106 and 107). The frame body 100 has a rectangular parallel piped shape.

The pillars 103 and 104 extend upward respectively from a left end upper portion and a right end upper portion of the frame 106. The pillar 105 is disposed adjacent to the right end of the frame 107 and extends upward. As shown in FIG. 4 and FIG. 5, the supporting member 111 is secured on upper portions of the pillars 103 and 104, and the supporting member 112 is secured on an upper portion of the pillar 105.

The supporting member 111 (first supporting member) is made of a metal plate that is elastically deformed easily by stress from the outside, and thus is formed as an elastic body. As shown in FIG. 4, the supporting member 111 is secured between an upper portion of the frame body 100 (more specifically, an upper portion of the frame body 100 located on a farther side as viewed from the user that operates the operation panel 9) and a bottom portion of the scanner 3 of the image reader 5 (more specifically, a bottom portion around a long side of the scanner 3). Specifically, the supporting member 111 is coupled to the one side of the frame body 100 (pillars 103 and 104) on a farther side as viewed from the user. The side at which the supporting member 111 is supported extends in a direction in which the recording medium P is conveyed in the image forming unit 6, and in a direction orthogonal to the movement direction of the mirror group 16 (e.g., upper-lower direction).

Thus, the image reader 5 is supported to the frame body 100 by the supporting member 111 in a cantilever manner. The supporting member 111 is more deflected at a portion farther from a position secured to the frame body 100 in a direction along the shorter side of the image reader 5.

As shown in FIG. 4, the supporting member 112 (second supporting member) is secured to an upper portion of the frame body 100 (more specifically, an upper portion of the frame body 100 on a closer side as viewed from the user). Specifically, the supporting member 112 is coupled to an end portion (pillar 105) of a side of the frame body 100 not coupled to the supporting member 111. Thus, the supporting member 112 receives a bottom portion of the scanner 3 of the image reader 5 supported by the supporting member 111 in a cantilever manner.

As shown in FIG. 3, the hinges 121 (121a and 121b) are disposed right above the supporting member 111, or portions right above the supporting member 111 to be capable of minimizing the influence of vibration caused by opening or closing the ADF 4.

With the hinges 121 (121a and 121b), the ADF 4 swings about a swing shaft adjacent to the supporting member 111, and the ADF 4 opens and closes on a side of the supporting member 112 (closer side as viewed from the user that operates the operation panel 9). Specifically, the ADF 4 is not opened and closed on the side of the supporting member 111 that supports the image reader 5 in a cantilever manner (farther side as viewed from the user that operates the operation panel 9). Thus, the ADF 4 can be favorably opened and closed with the image reader 5 supported in a cantilever manner.

As is apparent from FIG. 1 and FIG. 4, the operation panel 9 is disposed at a portion right above the supporting member 112. Thus, the supporting member 112 is not deflected by the operation on the operation panel 9 by the user. Thus, the image reader 5 can favorably read an image from the document without being affected by the used condition of the operation panel 9.

### 4. Vibration Absorption by Supporting Member

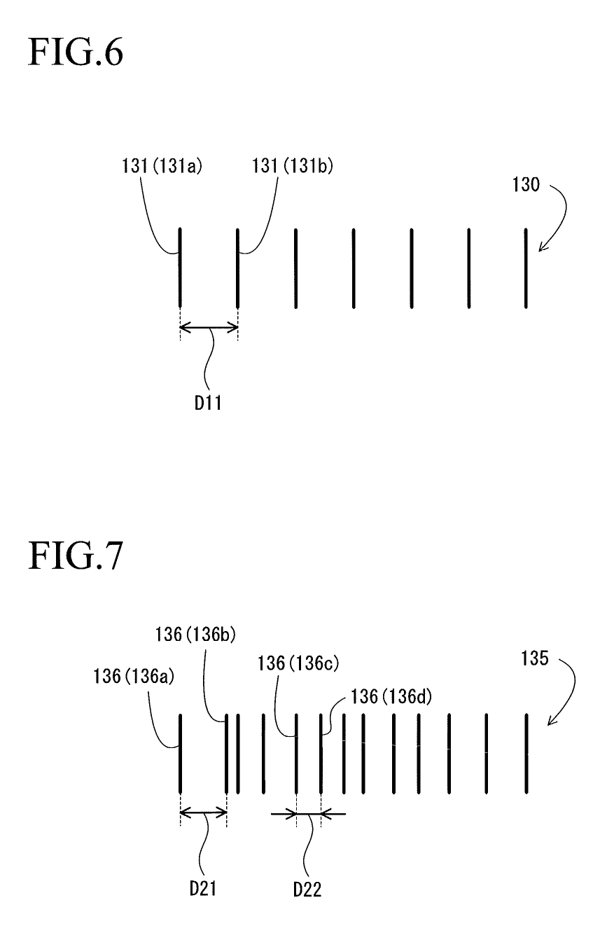

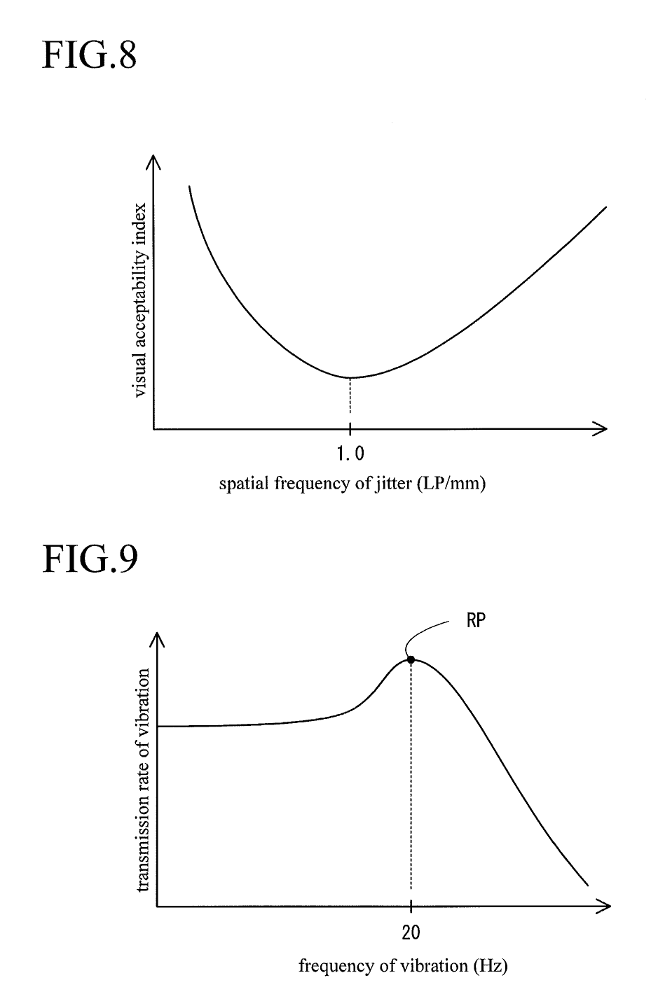

FIG. 6 and FIG. 7 describe jitter in a printed image. FIG. 8 is a graph illustrating a relationship between visual acceptability index and a spatial frequency of a jitter.

FIG. 9 is a graph depicting a relationship between a transmission rate of vibration and a frequency of vibration.

The jitter is a phenomenon where the intervals among a plurality of printed elements that should be printed at an equal interval in one direction differ from one another (fluctuate) in accordance with a frequency of vibration applied to an image forming unit, vary in size (each interval is varied).

For example, when vibration transmitted to the image reader 5 does not affect image formation, printed elements 131 (131a and 131b) of a print image 130 are printed at an equal interval D11 as shown in FIG. 6.

In contrast, when vibration is transmitted from the image reader 5 to the image forming unit 6, different intervals D21 and 22 are provided among printed elements 136 (136a to 136d) of a print image 135 as shown in FIG. 7.

Relationship between a range acceptable by visual characteristics of people (visually acceptability index) and a spatial frequency of the jitter is as shown in FIG. 8. The acceptable range is known to be narrowest with a spatial frequency f1 of jitter of about “1.0” (LP/mm) as shown in FIG. 8. A frequency 12 of vibration corresponding to the spatial frequency f1, which depends on the printing speed of the image forming unit 6, is generally about “50” to “200” (Hz).

Therefore, for favorable image forming, vibration of the frequency f2 in such a range needs to be prevented from being transmitted from the image reader 5 to the image forming unit 6.

Relationship between transmission characteristics of vibration and a frequency of vibration is as shown in FIG. 9. As shown in FIG. 9, transmission rate of vibration rises near a resonance point RP, but sharply drops as a frequency exceeds the resonance point RP.

In the embodiment, the resonance frequency of the supporting member 111 of a cantilever supporting structure is set to about “20” (Hz), and thus is smaller than the frequency f2 (=“50” to “200”) of the vibration that causes printing failure caused by jitter.

Accordingly, the vibration that causes the jitter is absorbed by the supporting member 111 and thus is not transmitted to the frame body 100 and the image forming unit 6. Thus, printing failure such as jitter can be prevented, and a favorable print image can be acquired. The vibration generated in the image forming unit 6 is also absorbed by the supporting member 111. Thus, a read image can be favorably acquired by the image reader 5.

### 5. Advantage of Image Forming Apparatus of this Embodiment

As described above, in the MFP 1 of this embodiment, the supporting member 111 (first supporting member) supports the image reader 5 in a cantilever manner and is formed as an elastic body. Thus, the supporting member 111 is deflected by the vibration generated in the image reader 5, and thus absorbs the vibration. Accordingly, the vibration can be prevented from being transmitted to the image forming unit 6 incorporated in the frame body 100, and the print failure can be prevented.

As shown in FIG. 3, the bottom portion adjacent to the longer side of the image reader 5 is secured to the supporting member 111. Thus, a distance between a position at which the supporting member 111 is secured to the frame body 100 and a position of the free end of the image reader 5 supported by the supporting member 111 in a cantilever manner is approximately the same as the shorter side length of the image reader 5.

Accordingly, the image reader 5 can be more stably supported in a cantilever manner and the vibration generated in the image reader 5 can be more favorably absorbed by the supporting member 111 compared with a case where a bottom portion adjacent to the shorter side of the image reader 5 is secured on the supporting member 111.

### 6. Modification

It will be appreciated that the present invention will not be limited to this embodiment described above and can be embodied in various other forms.

For example, while the image reader 5 including the scanner 3 and the ADF 4 has been described, this should not be construed in a limiting sense. For example, the image reader 5 may include a document holder having no ADF function instead of the ADF 4.

In this case, the document holder swings about a swing shaft adjacent to the supporting member 111, and the document holder opens and closes on a side of the supporting member 112 (closer side as viewed from the user that operates the operation panel 9). Thus, he document holder can be favorably opened and closed with the image reader 5 supported in a cantilever manner.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. An image forming apparatus comprising:
a frame body;
an image forming unit accommodated in a space defined by the frame body;
an image reader disposed above the image forming unit;
a first supporting member secured between an upper portion of the frame body and a bottom portion of the image reader and configured to support the image reader to the frame body in a cantilever manner; and
a second supporting member secured on an upper portion of the frame body and configured to receive a bottom portion of the image reader supported by the first supporting member in a cantilever manner.

2. The image forming apparatus according to claim 1, wherein a longer side end of the image reader is secured to the first supporting member.

3. The image forming apparatus according to claim 1, wherein an operation unit configured to receive an input from a user is disposed at a portion right above the second supporting member.

4. The image forming apparatus according to claim 1,
wherein the image reader comprises:
a document holder configured to hold a document as a read target; and
a hinge configured to allow the document holder to be opened and closed,
wherein the hinge is disposed at a portion right above the first supporting member, and
wherein the document holder opens and closes on a side of the second supporting member by swinging about a swing shaft of the hinge.

5. The image forming apparatus according to claim 1,
wherein, the image reader comprises:
an automatic document feeder configured to feed a document as a read target so that an image on the document is read; and
a hinge that allows the automatic document feeder to open and close,
wherein the hinge is disposed at a portion right above the first supporting member, and
wherein the automatic document feeder opens and closes on a side of the second supporting member by swinging about a swing shaft of the hinge.

6. The image forming apparatus according to claim 1,
wherein the frame body has a rectangular parallel piped shape,
wherein the first supporting member is coupled to a side of the frame body, and
wherein the second supporting member is coupled to the frame body at an end portion of a side not coupled to the first supporting member.

7. The image forming apparatus according to claim 6, wherein the side coupled to the first supporting member extends in a direction in which a recording medium is conveyed in the image forming unit.

8. The image forming apparatus according to claim 7,
wherein the image reader comprises:
a platen glass;
an image sensor; and
a mirror group movable on a lower portion of the platen glass and configured to guide reflected light from a document on the platen glass to the image sensor, and
wherein the side coupled to the first supporting member extends in a direction orthogonal to a direction in which the mirror group moves.

9. The image forming apparatus according to claim 1,
wherein the feeder comprises a removable sheet feed cassette
wherein the recording medium is accommodated in the sheet feed cassette, and
wherein a length of the sheet feed cassette in a conveyance direction of the recording medium is smaller than a length of the sheet feed cassette in a direction orthogonal to the conveyance direction of the recording medium.
